(19) United States
(12) Patent Application Publication
(10) Pub. No.: US 2023/0288786 A1
(43) Pub. Date: Sep. 14, 2023

(54) GRAPHIC USER INTERFACE SYSTEM FOR IMPROVING THROUGHPUT AND PRIVACY IN PHOTO BOOTH APPLICATIONS

(71) Applicant: SMPL Inc., Austin, TX (US)

(72) Inventors: Mark Hennings, Austin, TX (US); Jeremy Cox, Austin, TX (US); Alex Kirts, Austin, TX (US); Nick Federoff, Austin, TX (US)

(21) Appl. No.: 18/082,414

(22) Filed: Dec. 15, 2022

Related U.S. Application Data
(60) Provisional application No. 63/361,377, filed on Dec. 15, 2021.

(51) Int. Cl. G03B 17/53; G06F 3/04845; G06V 40/16

(52) U.S. Cl. CPC G03B 17/53; G06F 3/04845; G06V 40/161

(57) ABSTRACT

Disclosed herein are systems and methods for displaying graphical user interface (GUI). An example method comprises generating a first graphical user interface GUI displaying images from a shared library. The example method comprises displaying a second GUI displaying a start screen that enables a user to initiate the session. The example method comprises displaying a third GUI displaying capture formats available during a session. The example method comprises capturing data from an image sensor associated with a camera. The example method comprises displaying a fourth GUI displaying captured data in the format selected by the user and displaying graphical user interface elements to edit the displayed captured data. The example method comprises displaying a fifth GUI comprising graphical interface elements displaying privacy options. The example method comprises displaying a sixth GUI comprising graphical interface elements enabling a user to send captured data in accordance with a privacy selection.

### CROSS-REFERENCE TO RELATED APPLICATIONS

This application claims priority to and benefit of U.S. Provisional Pat. Application, Serial No. 63/361,377, filed on Dec. 15, 2021, titled “SYSTEMS AND METHODS FOR STREAMLINING THROUGHPUT AT A PHOTO BOOTH APPLICATION.” That application is incorporated by reference in its entirety.

### BACKGROUND

### Field of the Art

This disclosure relates to graphical user interface (GUI) systems and methods for improving throughput and privacy in photo booth applications.

### Discussion of the State of the Art

It is common for a photo booth to be set up at a social event. A user may use the photo booth to capture images to commemorate the social event. The images captured may be displayed on social media associated with the social event or on social media. However, the user may only wish to share a portion of the images captured publicly. What is needed are systems and methods that allow a user to control privacy settings associated with captured images at a photo booth.

### SUMMARY

Disclosed herein are systems and methods for displaying graphical user interface (GUI). An example method may comprise generating a first graphical user interface (first GUI) for display on a first computing device. The first GUI may display images from a shared library. The example method may comprise receiving proximity detection data from a sensor. The proximity detection data may suggest that a human is ready to initiate a session. The example method may comprise displaying a second graphical user interface (second GUI) in response to the received proximity detection data. The second GUI may display a start screen that enables a user to initiate the session. The example method may comprise displaying a third graphical user interface (third GUI) in response to receiving an initiation request. The third GUI may display capture formats available during a session. A user may select at least one capture format. The example method may comprise capturing data from an image sensor associated with a camera. The captured data may be capable of being output in the capture format selected by the user. The example method may comprise displaying a fourth graphical user interface (fourth GUI) displaying captured data in the format selected by the user and displaying graphical user interface elements to edit the displayed captured data. The example method may comprise displaying a fifth graphical user interface (fifth GUI) comprising graphical interface elements displaying privacy options. The privacy options may enable a user to at least one of share the captured data privately, share the data publicly with some restrictions, and share the data publicly with no restrictions. The example method may comprise displaying a sixth graphical user interface (sixth GUI) comprising graphical interface elements enabling a user to send captured data in accordance with a privacy selection. The sent captured data may be edited.

The selected capture format may comprise capturing a single image.

The selected capture format may comprise capturing multiple images.

The selected capture format may comprise at least a first image and a last image.

The selected capture format may comprise replaying the multiple captured images in sequence from the first image to the last image.

The selected capture format may comprise replaying the sequence in a loop.

The selected capture format may comprise replaying the multiple captured images in a first sequence from the first image to the last image and then in a second sequence from the last image to the first image.

The selected capture format may comprise replaying the first sequence and then the second sequence in a loop.

A link to access the captured data may be sent to the user.

When a user selects to share the data publicly with no restrictions, the captured data may be transmitted to a first database. The database may be accessed for public display on a screen.

When a user selects to share the data publicly with some restrictions, the captured data may be transmitted to a first database with flags for selected restrictions. The first database may be accessed for public display in accordance with the selected restrictions.

Capturing data from an image sensor associated with a camera may comprise displaying a seventh graphical user interface (GUI). The seventh GUI may comprise a countdown.

Proximity detection data may comprise data from a depth sensing camera suggesting that a face of a threshold size is detected.

Proximity detection data may comprise data from at least one of a proximity sensor and ambient light sensor.

Disclosed herein are systems and methods for displaying graphical user interface (GUI). An example system may comprise a processor and memory. The memory may comprise stored instructions. When executed, the stored instructions may cause the processor to generate a first graphical user interface (first GUI) for display on a first computing device. The first GUI may display images from a shared library. When executed, the stored instructions may cause the processor to receive proximity detection data from a sensor. The proximity detection data may suggest that a human is ready to initiate a session. When executed, the stored instructions may cause the processor to display a second graphical user interface (second GUI) in response to the received proximity detection data. The second GUI may display a start screen that enables a user to initiate the session. When executed, the stored instructions may cause the processor to display a third graphical user interface (third GUI) in response to receiving an initiation request. The third GUI may display capture formats available during a session. A user may select at least one capture format. When executed, the stored instructions may cause the processor to capture data from an image sensor associated with a camera. The captured data may be capable of being output in the capture format selected by the user. When executed, the stored instructions may cause the processor to display a fourth graphical user interface (fourth GUI) displaying captured data in the format selected by the user and displaying graphical user interface elements to edit the displayed captured data. When executed, the stored instructions may cause the processor to display a fifth graphical user interface (fifth GUI) comprising graphical interface elements displaying privacy options. The privacy options may enable a user to at least one of share the captured data privately, share the data publicly with some restrictions, and share the data publicly with no restrictions. When executed, the stored instructions may cause the processor to display a sixth graphical user interface (sixth GUI) comprising graphical interface elements enabling a user to send captured data in accordance with a privacy selection. The sent captured data may be edited.

The selected capture format may comprise capturing a single image.

The selected capture format may comprise capturing multiple images.

The selected capture format may comprise at least a first image and a last image.

The selected capture format may comprise replaying the multiple captured images in sequence from the first image to the last image.

The selected capture format may comprise replaying the sequence in a loop.

The selected capture format may comprise replaying the multiple captured images in a first sequence from the first image to the last image and then in a second sequence from the last image to the first image.

The selected capture format may comprise replaying the first sequence and then the second sequence in a loop.

A link to access the captured data may be sent to the user.

When a user selects to share the data publicly with no restrictions, the captured data may be transmitted to a first database. The database may be accessed for public display on a screen.

When a user selects to share the data publicly with some restrictions, the captured data may be transmitted to a first database with flags for selected restrictions. The first database may be accessed for public display in accordance with the selected restrictions.

Capturing data from an image sensor associated with a camera may comprise displaying a seventh graphical user interface (GUI). The seventh GUI may comprise a countdown.

Proximity detection data may comprise data from a depth sensing camera suggesting that a face of a threshold size is detected.

Proximity detection data may comprise data from at least one of a proximity sensor and ambient light sensor.

### BRIEF DESCRIPTION OF THE DRAWING FIGURES

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 illustrates an environment for streamlining throughput at a photo booth in accordance with an exemplary embodiment of the invention.

FIG. 2A illustrates a screen used in a system for streamlining throughput and/or managing privacy for images captured at a photo booth in accordance with an exemplary embodiment of the invention.

FIG. 2B illustrates a screen used in a system for streamlining throughput and/or managing privacy for images captured at a photo booth in accordance with an exemplary embodiment of the invention.

FIG. 2C illustrates a screen used in a system for streamlining throughput and/or managing privacy for images captured at a photo booth in accordance with an exemplary embodiment of the invention.

FIG. 2D illustrates a screen used in a system for streamlining throughput and/or managing privacy for images captured at a photo booth in accordance with an exemplary embodiment of the invention.

FIG. 2E illustrates a screen used in a system for streamlining throughput and/or managing privacy for images captured at a photo booth in accordance with an exemplary embodiment of the invention.

FIG. 2F illustrates a screen used in a system for streamlining throughput and/or managing privacy for images captured at a photo booth in accordance with an exemplary embodiment of the invention.

FIG. 2G illustrates a screen used in a system for streamlining throughput and/or managing privacy for images captured at a photo booth in accordance with an exemplary embodiment of the invention.

FIG. 2H illustrates a screen used in a system for streamlining throughput and/or managing privacy for images captured at a photo booth in accordance with an exemplary embodiment of the invention.

FIG. 2I illustrates a screen used in a system for streamlining throughput and/or managing privacy for images captured at a photo booth in accordance with an exemplary embodiment of the invention.

FIG. 2J illustrates a screen used in a system for streamlining throughput and/or managing privacy for images captured at a photo booth in accordance with an exemplary embodiment of the invention.

FIG. 3 illustrates a flowchart for streamlining throughput at a photo booth in accordance with an exemplary embodiment of the invention.

FIG. 4 illustrates components of an exemplary computing device that supports an embodiment of the inventive disclosure.

FIG. 5 illustrates one embodiment of a standalone computing system that supports an embodiment of the inventive disclosure.

FIG. 6 illustrates an exemplary distributed computing network that supports an exemplary embodiment of the inventive disclosure.

FIG. 7 illustrates an exemplary overview of a computer system that supports an exemplary embodiment of the inventive disclosure.

FIG. 8 illustrates a flowchart for managing privacy for images captured at a photo booth in accordance with an exemplary embodiment of the invention.

### DETAILED DESCRIPTION OF EMBODIMENTS

The inventive systems and methods (hereinafter sometimes referred to more simply as “system” or “method”) described herein for streamlining throughput at a photo booth. Specifically, the inventive systems and methods present a user with a plurality of pictures taken contemporaneously. The inventive systems and methods allow the user to select which of the plurality of pictures the user would like to shield from public viewing. The inventive systems and methods may cause pictures not designated as private to be publicly viewed contemporaneously and transmit all of the plurality of pictures to a point of contact specified by the user. The present invention speeds up the process of taking pictures in a photo booth. The present invention simplifies the process of blocking pictures from public view. The present invention shortens the time it takes to present pictures publicly after the pictures were taken in a photo booth. The present invention creates a bond of trust between the photo booth system and the participants. The present invention encourages participants to take more photos since the participants can control where the photos will be visible. Further, the present invention is beneficial to whoever has set up the photo booth, because the entity that sets up the photo booth can now confidently do more things with the images that are “public.”

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

### Conceptual Architecture

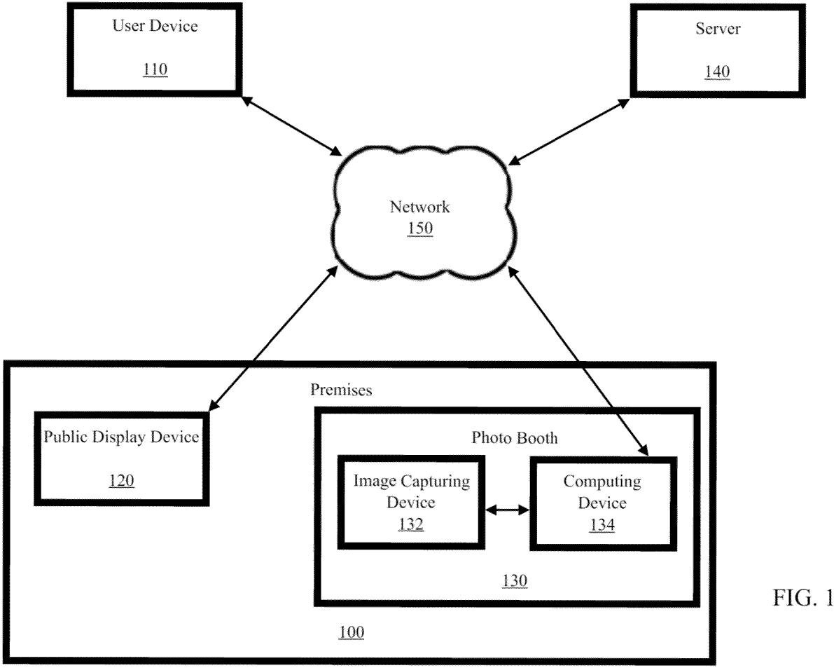

FIG. 1 illustrates an environment for streamlining throughput at a photo booth in accordance with an exemplary embodiment of the invention. The environment comprises a premises 100, a user device 120, a server 140, and a network 150. The premises 100 may comprise a public display device 120 and a photo booth 130. The various computing devices described herein are exemplary and for illustration purposes only. The system may be reorganized or consolidated, as understood by a person of ordinary skill in the art, to perform the same tasks on one or more other servers or computing devices without departing from the scope of the invention.

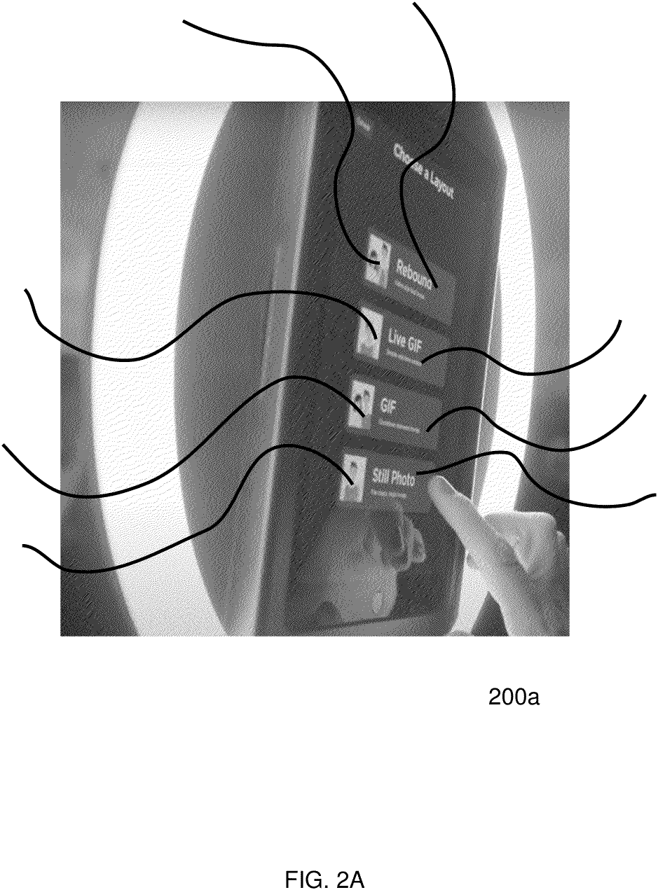

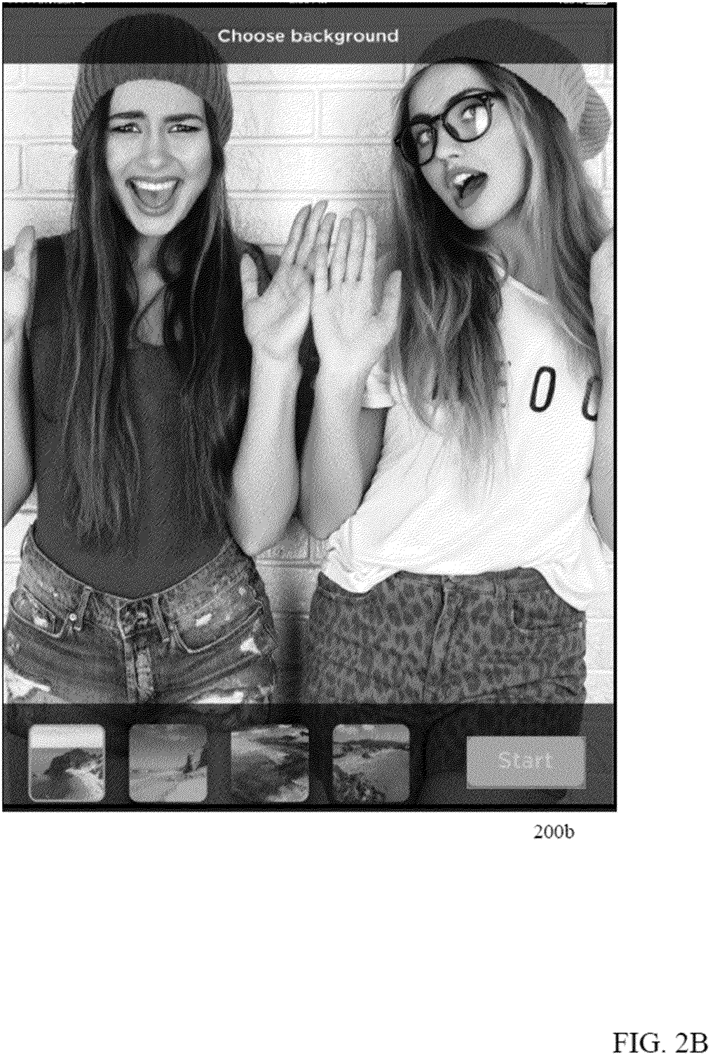

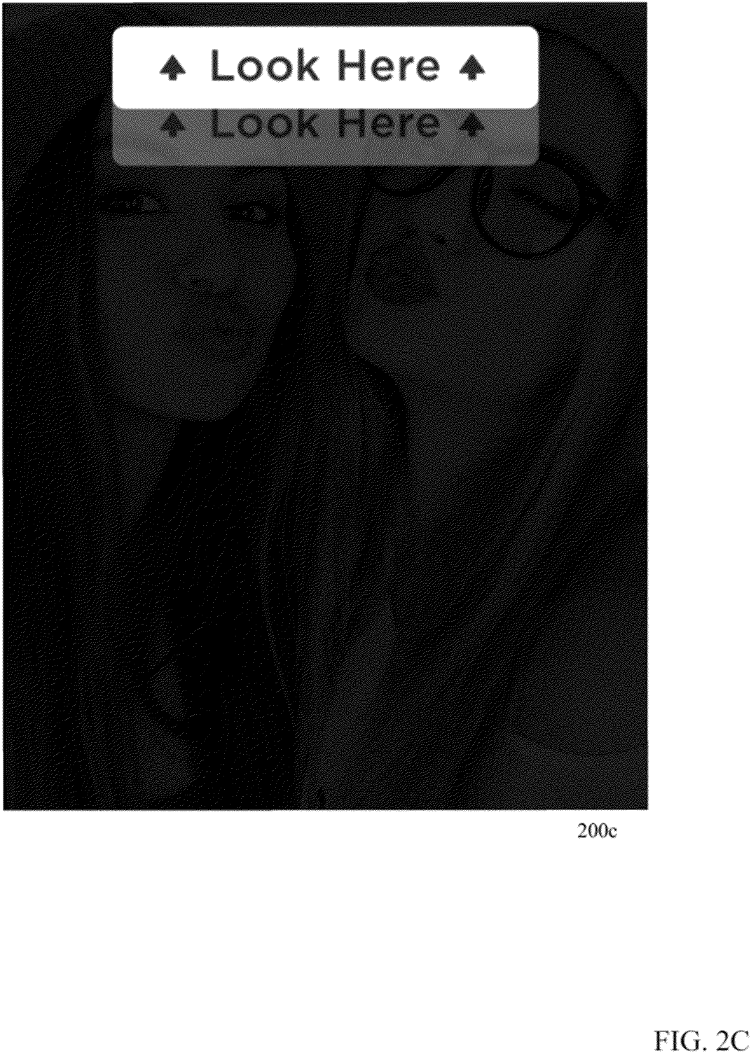

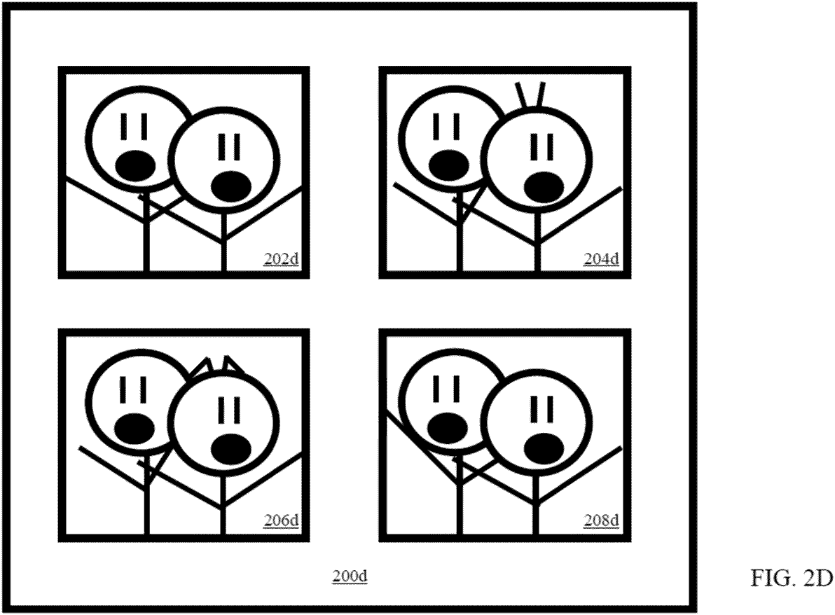

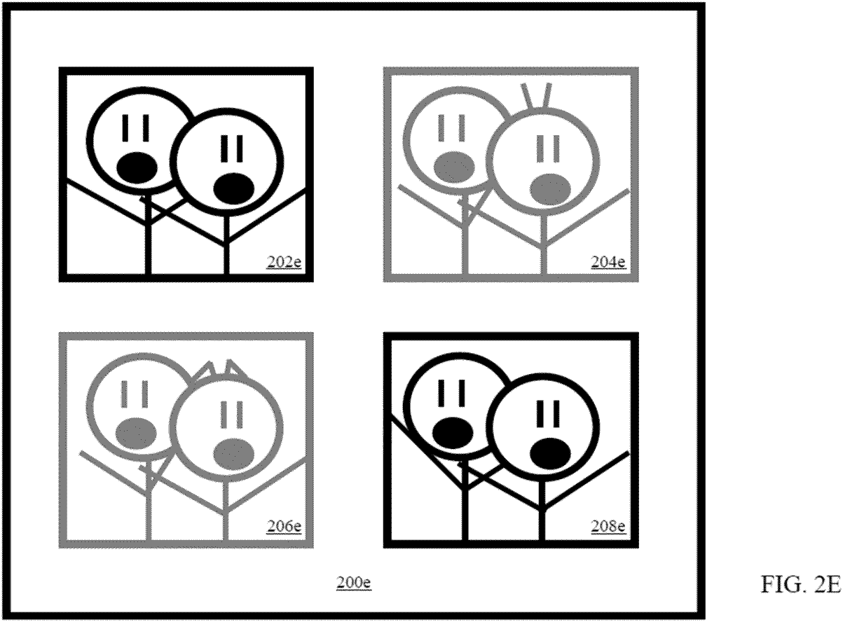

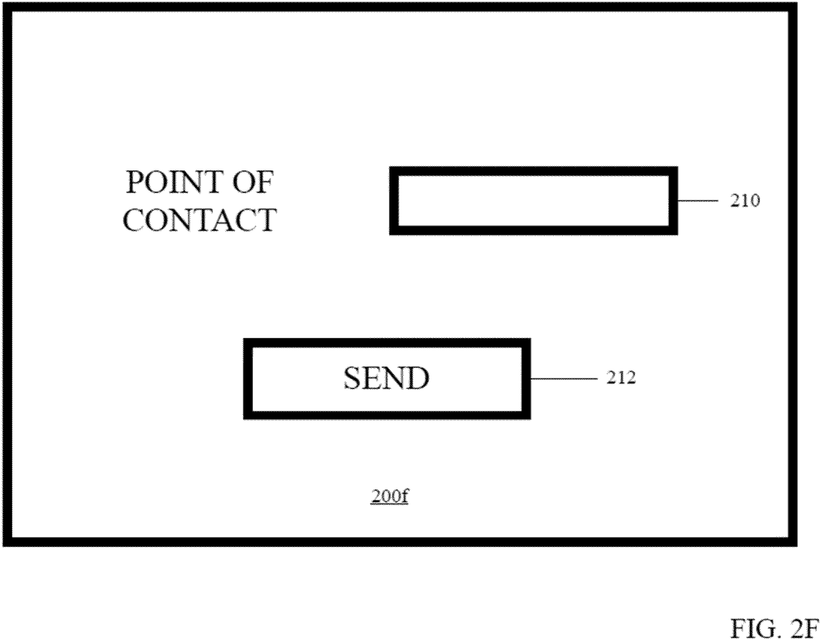

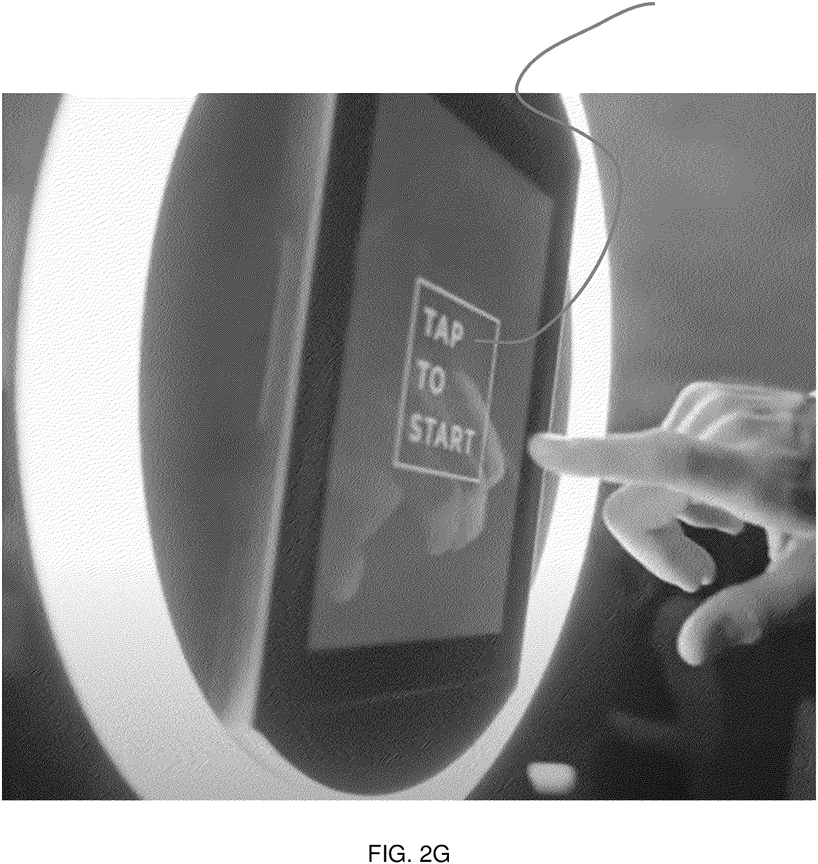

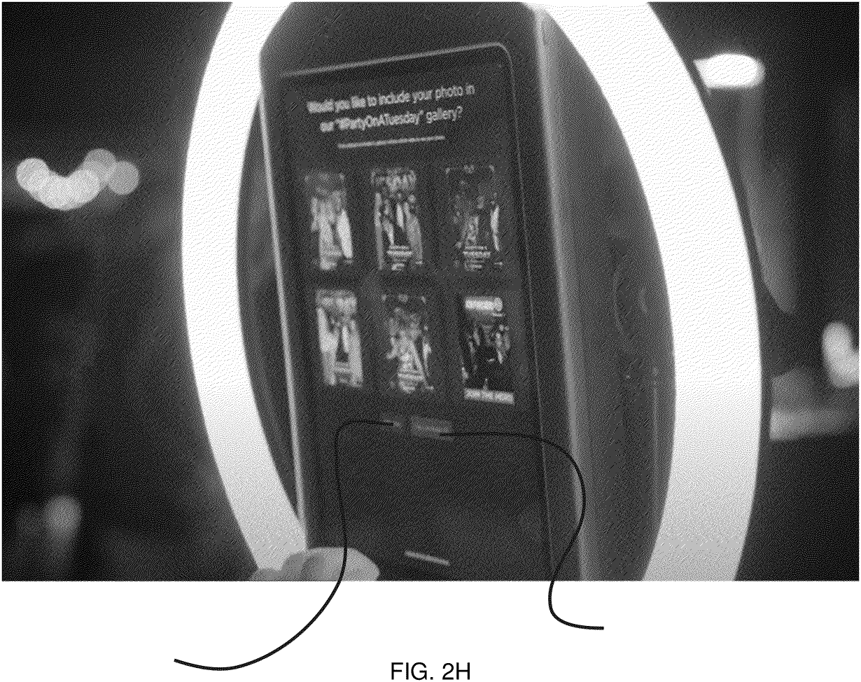

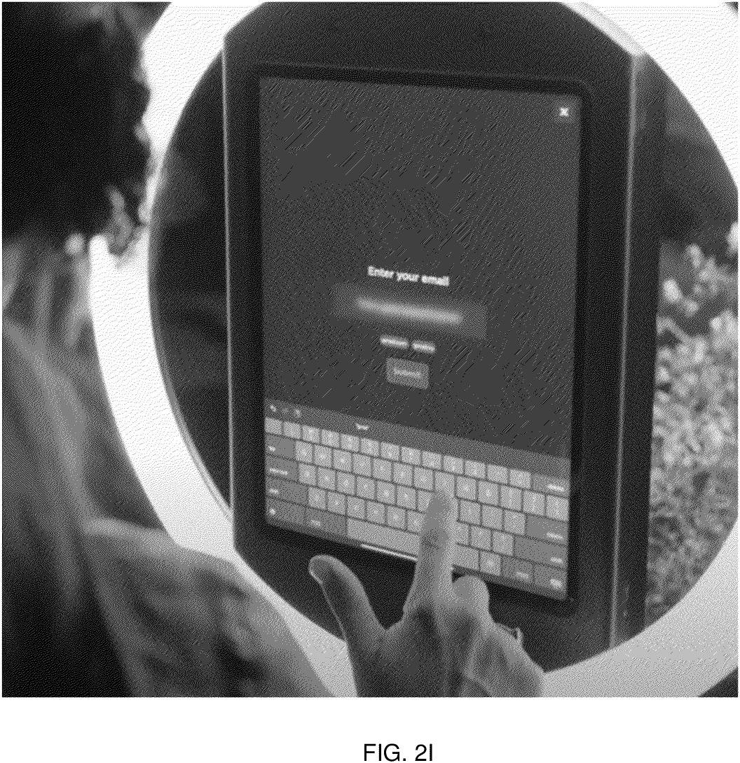

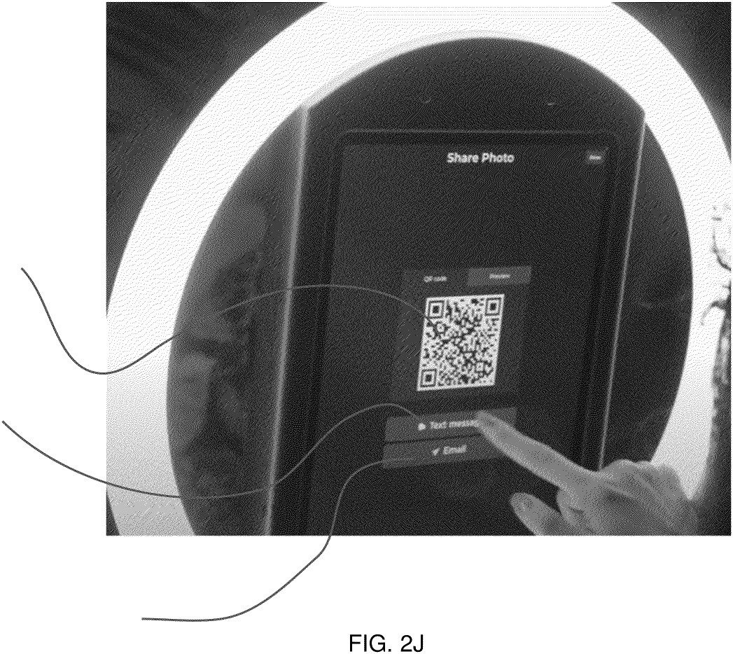

The premises 100 may be or comprise an area for events that people may want to commemorate with photos. The premises 100 may host events, such as weddings, parties, etc. The public display device 120 may comprise a smart television, monitor, etc. The photo booth 130 may comprise an image capturing device 132 and a computing device 134. The image capturing device 132 and the computing device 134 may comprise components integrated into a single device. The image capturing device 132 and the computing device 134 may comprise separate devices. The image capturing device 132 may comprise a camera. The image capturing device 132 may comprise a detectable camera lens. The computing device 134 may comprise a tablet. The computing device 134 may comprise a private display. The private display may display screens, such as the screens illustrated in FIGS. 2A-2F. The image capturing device 132 may transmit captured images to the computing device 134 for approval for public showing. In one embodiment, the computing device 134 may transmit approved images to the public display device 120 via the network 150. Although not shown, the computing device 134 may transmit approved images to the public display device 120 directly. The computing device 134 may transmit captured images to the server 140 via the network 150. In one embodiment, the server 140 may transmit approved images to the public display device 120 via the network 150. The computing device 134 may cause the captured images or a link to access the captured images to be transmitted to a location accessible via the network 150 by an application, such as an email application, executed on the user device 110. Although the public display device 120 is shown on the premises 100, in another embodiment the public display device 120 may be at another location, such as on a billboard or projected onto a structure or at a remote location with people unable to attend an event in person.

The user device 110 and/or the computing device 134 may comprise a browser for accessing a web application hosted on the server 140. The user device 110 and/or the computing device 134 may comprise an application for interacting with a web application hosted on the server 140. The user device 110 and/or the computing device 134 may comprise an application obtained from the server 140.

The user device 110 and/or the computing device 134 (herein referred to as user input device, computing device, or client device) may include, generally, a computer or computing device including functionality for communicating (e.g., remotely) over the network 150. The user device 110 and/or the computing device 134 may be a server, a desktop computer, a laptop computer, personal digital assistant (PDA), an in- or out-of-car navigation system, a smartphone or other cellular or mobile phone, or mobile gaming device, among other suitable computing devices. The user device 110 and/or the computing device 134 may execute one or more client applications, such as a web browser (e.g., Microsoft Windows Internet Explorer, Mozilla Firefox, Apple Safari, Google Chrome, and Opera, etc.), or a dedicated application for photo capturing and transmission.

In particular embodiments, the user device 110 and/or the computing device 134 may be an electronic device including hardware, software, or embedded logic components or a combination of two or more such components and capable of carrying out the appropriate functions implemented or supported by the user device 110 and/or the computing device 134. For example and without limitation, the user device 110 and/or the computing device 134 may be a desktop computer system, a notebook computer system, a netbook computer system, a handheld electronic device, or a mobile telephone. The present disclosure contemplates any user device as the user device 110 and/or the computing device 134. The user device 110 and/or the computing device 134 may enable a network user to access network 150. The user device 110 and/or the computing device 134 may communicate with other computing devices.

The user device 110 and/or the computing device 134 may have a web browser, such as MICROSOFT INTERNET EXPLORER, GOOGLE CHROME, APPLE SAFARI, OPERA, or MOZILLA FIREFOX, and may have one or more add-ons, plug-ins, or other extensions, such as TOOLBAR or YAHOO TOOLBAR. The user device 110 and/or the computing device 134 may enable a user to enter a Uniform Resource Locator (URL) or other address directing the web browser to a server, such as the server 140, and the web browser may generate a Hyper Text Transfer Protocol (HTTP) request and communicate the HTTP request to the server. The server may accept the HTTP request and communicate to the user device 110 and/or the computing device 134 one or more Hyper Text Markup Language (HTML) files responsive to the HTTP request. The user device 110 and/or the computing device 134 may render a web page based on the HTML files from the server for presentation to the user. The present disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

This disclosure contemplates any suitable number of client devices, including computing systems taking any suitable physical form. As example and not by way of limitation, computing systems may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computing system may include one or more computer systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example, and not by way of limitation, one or more computing systems may perform in real time or in batch mode one or more steps of one or more methods described or illustrated herein. One or more computing system(s) may perform at different times or at different locations one or more steps of one or more methods described or illustrated herein, where appropriate.

The server 140 may comprise one or more computing devices. The server 140 may comprise a cloud computing environment. The server 140 may host a website. The server 140 may host a web application. The server 140 may provide applications, such as mobile applications, for download by the user device 110 and/or the computing device 134 via the network 150. The server 140 may receive communications from the user device 110 and/or the computing device 134 via the network 150.

The network 150 may facilitate communication between the user device 110, the public display device 120, the computing device 134, and the server 140.

The network 150 generally represents a network or collection of networks (such as the Internet or a corporate intranet, or a combination of both) over which the various components illustrated in FIG. 1 (including other components that may be necessary to execute the system described herein, as would be readily understood to a person of ordinary skill in the art). In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 150 or a combination of two or more such networks 150. One or more links connect the systems and databases described herein to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable network 150, and any suitable link for connecting the various systems and databases described herein. The network 150 may comprise cellular networks.

The network 150 connects the various systems and computing devices described or referenced herein. In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network or a combination of two or more such networks 150. The present disclosure contemplates any suitable network 150.

One or more links couple one or more systems, engines or devices to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable links coupling one or more systems, engines or devices to the network 150.

In particular embodiments, each system or engine may be a unitary server or may be a distributed server spanning multiple computers or multiple datacenters. Systems, engines, or modules may be of various types, such as, for example and without limitation, web server, news server, mail server, message server, advertising server, file server, application server, exchange server, database server, or proxy server. In particular embodiments, each system, engine or module may include hardware, software, or embedded logic components or a combination of two or more such components for carrying out the appropriate functionalities implemented or supported by their respective servers. For example, a web server is generally capable of hosting websites containing web pages or particular elements of web pages. More specifically, a web server may host HTML files or other file types, or may dynamically create or constitute files upon a request, and communicate them to one or more computing device(s) or other devices in response to HTTP or other requests from one or more computing device(s) or other devices. A mail server is generally capable of providing electronic mail services to various one or more computing device(s) or other devices. A database server is generally capable of providing an interface for managing data stored in one or more data stores.

In particular embodiments, one or more data storages may be communicatively linked to one or more servers via one or more links. In particular embodiments, data storages may be used to store various types of information. In particular embodiments, the information stored in data storages may be organized according to specific data structures. In particular embodiments, each data storage may be a relational database. Particular embodiments may provide interfaces that enable servers or clients to manage, e.g., retrieve, modify, add, or delete, the information stored in data storage.

The system may also contain other subsystems and databases, which are not illustrated in FIG. 1, but would be readily apparent to a person of ordinary skill in the art. For example, the system may include databases for storing data, storing features, storing outcomes (training sets), and storing models. Other databases and systems may be added or subtracted, as would be readily understood by a person of ordinary skill in the art, without departing from the scope of the invention.

A user at a party at the premises 100 may interact with (e.g., approach, enter, etc.) the photo booth 130. The computing device 134 may present the user with an option of what capture format the user wants. After the user selects a capture format, the computing device 134 may present the user with background options. After the user selects a background, the computing device 134 may present a screen instructing the user on where to look for the picture. The computing device 134 may cause the image capturing device 132 to capture a plurality of images. The image capturing device 132 may transfer the plurality of images to the computing device 134. The computing device 134 may present the plurality of images to the user. The user may select the images which the user does not wish to share publicly. The computing device 134 may request a point of contact from the user and the user may enter a point of contact, such as a phone number or email address. The computing device 134 may transmit the plurality of images and associated share preferences to the server 140 via the network 150. The computing device 134 may cause the plurality of images to be sent to a location associated with the point of contact. The user may use the user device 110 to access the plurality of images at the location via the network 150. The computing device 134 and/or the server 140 may cause the plurality of images which the user did not select to be displayed on the public display device 120 in the premises 100 at the party.

In a second embodiment, the default setting for the plurality of images may be private. In the second embodiment, the computing device 134 may transmit the plurality of images to the server 140 via the network 150 before the computing device 134 receives privacy information for the plurality of images. The computing device 134 may transmit updated privacy information to the server 140 once the user makes privacy selections.

In a third embodiment, the user device 110 may receive a unique code associated with the plurality of images stored in the server 140. The user may use the user device 110 and the received unique code to change the privacy setting associated with the plurality of images stored in the server 140. Additionally, the user may use the user device 110 and the received unique code to delete and/or edit the plurality of images stored in the server 140. Editing the plurality of images may include adding a filter, effects, a logo, a brand, reprocessing, etc. The unique code may be received in response to entering the point of contact. The unique code may be received via scanning a Quick Response QR code.

### Screens for Streamlining Throughput And/or Managing Privacy for Images Captured at a Photo Booth

FIGS. 2A-2J illustrate screens that may be used in a system for streamlining throughput and/or managing privacy for images captured at a photo booth in accordance with an exemplary embodiment of the invention. FIG. 2A illustrates a screen 200a that may be shown on the computing device 134 in FIG. 1 when a user enters the photo booth 130 in FIG. 1. The screen 200a may give the user options for a capture format. The capture format options may comprise one or more format options comprising single images. For example, the screen 200a comprises an example graphical user interface (GUI) element for selecting a single image 218a and a corresponding preview window for the single image 208a. The capture format options may comprise one or more format options comprising multiple images. An example format option comprises images in an animation where each image is a frame sequenced in time. An example format option comprising multiple images may display the multiple images in a same order in a loop. An example format option comprising a gif. For example, the screen 200a comprises an example GUI element for selecting a gif 216a and a corresponding preview window for the gif 206a. An example format option comprises a gif shared instantaneously (e.g., real-time) with an audience, such as on a social media platform or on a screen at the event (e.g., live gif). For example, the screen 200a comprises an example GUI element for selecting a live gif 214a and a corresponding preview window for the live gif 204a. An example format option comprising multiple images may display the multiple images in a first order and then a second order, where the second order is the reverse of the first order. For example, the screen 200a comprises an example GUI element for selecting a rebound (e.g., boomerang) 212a and a corresponding preview window for the rebound 202a. An example format option comprising multiple images may comprise images forming a video. An example format option may comprise audio.

FIG. 2B illustrates a screen 200b that may be shown on the computing device 134 in FIG. 1 after the user makes a selection on the screen 200a in FIG. 2A. The screen 200b may give the user options for a background. The background options may be selected using artificial intelligence and/or machine learning to predict which backgrounds a user or group of users is likely to select. Artificial intelligence and/or machine learning may be used to better eliminate an actual background and insert a fake background, while persevering foreground objects, such as the user. The user may get a real-time preview of the background, using chroma key techniques (e.g., green screen, blue screen, etc.) and/or artificial intelligence and/or machine learning. Once selected, the background may automatically be placed in the background on a display screen.

FIG. 2C illustrates a screen 200c that may be shown on the computing device 134 in FIG. 1 after the user makes a selection on the screen 200b in FIG. 2B. The screen 200c may direct the user where to look while images are being captured. The screen 200c may continue to show the user a preview of the captured images. The screen 200c may lower the brightness of a display screen so as not to distract the user from where the display screen directs the user to look. The screen 200c may comprise a countdown until the images are captured.

FIG. 2D illustrates a screen 200d that may be shown on the computing device 134 in FIG. 1 after images are captured. The screen 200d may comprise a plurality of input elements comprising captured images, such as a first input element comprising a captured image 202d, a second input element comprising a captured image 204d, a third input element comprising a captured image 206d, and a fourth input element comprising a captured image 208d. The plurality of input elements comprising the captured images 202d-208d may be displayed in a manner that indicates that all of the images are permitted to be displayed in public by default. The plurality of input elements comprising the captured images 202d-208d may be displayed in full brightness by default. The plurality of input elements comprising the captured images 202d-208d may each comprise a checkbox. Each checkbox may be checked by default.

FIG. 2E illustrates a screen 200e that may be shown on the computing device 134 in FIG. 1 after the user selects two of the input elements on the screen 200d in FIG. 2D. The screen 200e may comprise a plurality of input elements comprising captured images, such as a first input element comprising a captured image 202e, a second input element comprising a captured image 204e, a third input element comprising a captured image 206e, and a fourth input element comprising a captured image 208e. The first input element comprising a captured image 202e may comprise the first input element comprising a captured image 202d in FIG. 2D, wherein the first input element comprising a captured image 202d in FIG. 2D has not been pressed or clicked. The second input element comprising a captured image 204e may comprise the second input element comprising a captured image 204d in FIG. 2D, wherein the second input element comprising a captured image 204d in FIG. 2D has been pressed or clicked. The third input element comprising a captured image 206e may comprise the third input element comprising a captured image 206d in FIG. 2D, wherein the third input element comprising a captured image 206d in FIG. 2D has been pressed or clicked. The fourth input element comprising a captured image 208e may comprise the fourth input element comprising a captured image 208d in FIG. 2D, wherein the fourth input element comprising a captured image 208d in FIG. 2D has not been pressed or clicked. The second input element comprising a captured image 204e and the third input element comprising a captured image 206e may be displayed in a manner that indicates that the images associated with the second input element comprising a captured image 204e and the third input element comprising a captured image 206e may are not permitted to be displayed in public. The second input element comprising a captured image 204e and the third input element comprising a captured image 206e may be displayed in less than full brightness. The second input element comprising a captured image 204e and the third input element comprising a captured image 206e may each comprise a checkbox that is unchecked.

FIG. 2F illustrates a screen 200f that may be shown on the computing device 134 in FIG. 1 after the user confirms selection of two of the input elements on the screen 200e in FIG. 2E. The screen 200f may comprise an input element for receiving a point of contact 210 and an input element to confirm an entered point of contact 212. The captured images or a link to access the captured images may be transmitted to a point of contact entered in the input element for receiving a point of contact 210. The point of contact may comprise one or more of a phone number, an email address, a social media account, etc.

FIG. 2G illustrates a screen comprising a graphical user interface (GUI) to display a start screen that enables a user to initiate a session. The screen may be displayed in response to receiving proximity detection data. The proximity detection data may be received from a sensor. The proximity detection data may suggest that a human is ready to initiate a session. Proximity detection data may comprise data from a depth sensing camera suggesting that a face of a threshold size is detected. Proximity detection data may comprise data from at least one of a proximity sensor and ambient light sensor. The screen may comprise a GUI element (e.g., button, etc.) 202g that a user engages (e.g., presses, etc.) to initiate a session.

FIG. 2H illustrates a screen comprising a graphical user interface (GUI) that may display captured data in the format selected by the user. The GUI may display graphical user interface elements to edit the displayed captured data. The GUI may display graphical interface elements displaying privacy options. The privacy options may enable a user to at least one of share the captured data privately, share the data publicly with some restrictions, and share the data publicly with no restrictions. The GUI may display elements corresponding to particular audiences (e.g., crowds, events, platforms, venues, etc.). The GUI may comprise a GUI element 202h that allows the user to opt in to making the captured data available for public display to selected particular audiences. The GUI may comprise a GUI element 204h that allows the user to opt out of making the captured data available for public display to selected particular audiences.

FIG. 2I illustrates a screen comprising a graphical user interface (GUI) that receives an e-mail address. FIG. 2J illustrates a screen comprising a GUI that receives share option associated with a photo. The GUI associated with FIG. 2J may comprise a first input element 204j to indicate transmission of information associated with the photo to a device associated with a phone number, a second input element 206j to indicate transmission of information associated with the photo to an email address, and a quick response (QR) code 202j associated with the photo. The QR code may reveal and/or comprise a link associated with the photo. The GUIs of FIG. 2I and/or FIG. 2J may comprise graphical interface elements enabling a user to send captured data in accordance with a privacy selection. The sent captured data may be edited.

### Processes for Streamlining Throughput at a Photo Booth

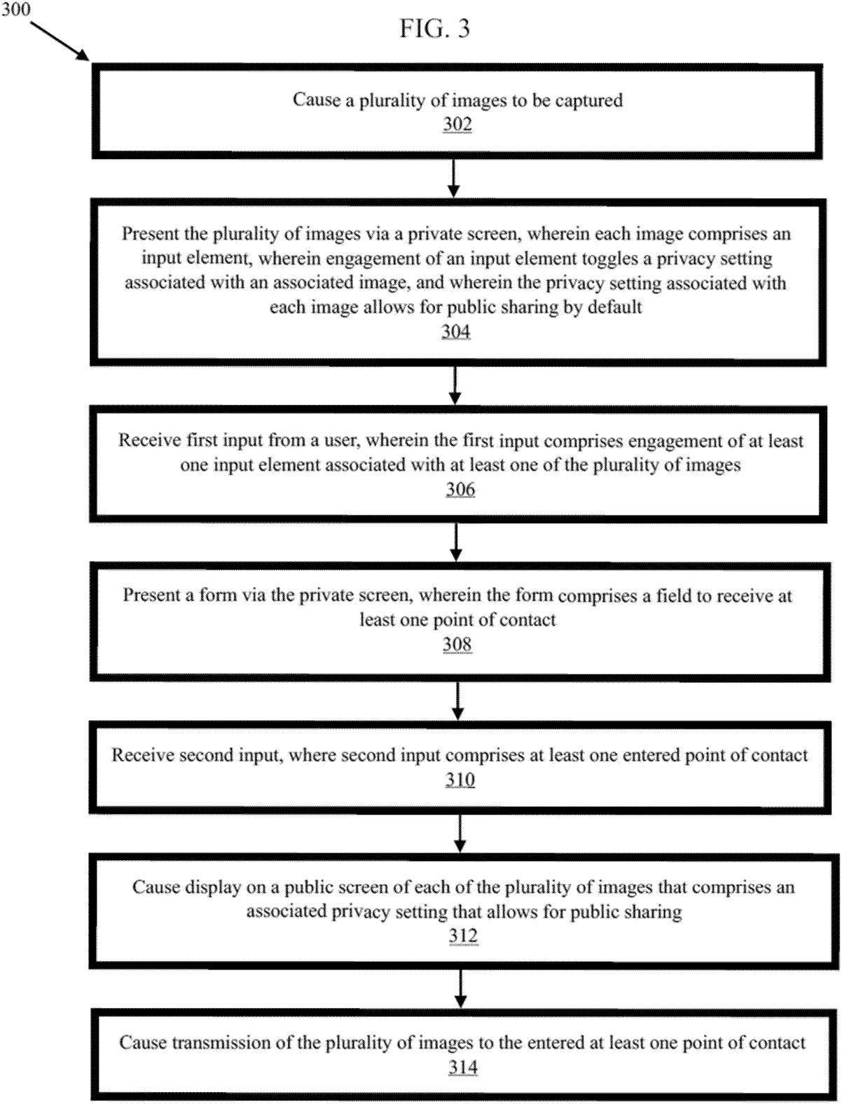

FIG. 3 illustrates, in an example embodiment, method 300 of streamlining throughput at a photo booth. In embodiments, the method steps or techniques depicted and described herein can be performed in a processor of the user device 110 in FIG. 1, the method steps being encoded as processor-executable instructions in a non-transitory memory of the user device 110. In embodiments, the method steps or techniques depicted and described herein can be performed in a processor the public display device 120 in FIG. 1, the method steps being encoded as processor-executable instructions in a non-transitory memory of the public display device 120. In embodiments, the method steps or techniques depicted and described herein can be performed in a processor the computing device 134 in FIG. 1, the method steps being encoded as processor-executable instructions in a non-transitory memory of the computing device 134. In embodiments, the method steps or techniques depicted and described herein can be performed in a processor of the server 140 in FIG. 1, the method steps being encoded as processor-executable instructions in a non-transitory memory of the server 140. The techniques of FIG. 3 may be implemented in an operating system kernel, in a separate user process, in a library package bound into network applications, on a specially constructed machine, on an application-specific integrated circuit (ASIC), or a field programmable gate array (FPGA).

At step 302, a plurality of images may be caused to be captured. The plurality of images may be captured in a format designated by a user. The format may comprise single images. The format may comprise multiple images. The format may comprise images in an animation where each image is a frame sequenced in time. The format may display the multiple images in a same order in a loop. The format may comprise a gif. The format may display the multiple images in a first order and then a second order, where the second order is the reverse of the first order. The format may comprise audio. The multiple images may form a video. The plurality of images may comprise a background selected by the user. The plurality of images may comprise multiple photo sessions taken in succession. Each of the plurality of images may comprise one or more images taken in a photo session.

At step 304, the plurality of images may be presented via a private screen. The computing device 134 in FIG. 1 may comprise the private screen. Each image may comprise an input element. The input element may be a button comprising an associated image. The input element may be a checkbox associated with an associated image. Engagement of an input element may toggle a privacy setting associated with an associated image. Engagement of the input element may comprise pressing the input element. Engagement of the input element may comprise clicking the input element. Toggling the privacy setting may comprise toggling between a lightened and a darkened version of the input element. Toggling the privacy setting may comprise toggling between putting something, such as an “X”, a dot, a checkmark, etc., on the input element, and removing the something from the input element. The privacy setting may indicate a willingness to share an associated image publicly. The privacy setting associated with each image may allow for public sharing by default. The privacy setting associated with each image may restrict public sharing by default.

At step 306, first input may be received from the user. The first input may comprise engagement of at least one input element associated with at least one of the plurality of images. Engagement of at least one input element associated with at least one of the plurality of images may comprise a press or click on at least one of the plurality of images. Engagement of at least one input element associated with at least one of the plurality of images may comprise a press or click on an input element next to at least one of the plurality of images. Engagement of at least one input element associated with at least one of the plurality of images may cause an engaged input element to toggle from an indication of inclusion in public display to an indication of exclusion from public display. Engagement of at least one input element associated with at least one of the plurality of images may cause an engaged input element to toggle from an indication of exclusion from public display to an indication of inclusion in public display.

At step 308, a form may be presented via the private screen. The computing device 134 in FIG. 1 may comprise the private screen. The form may comprise a field to receive at least one point of contact. The form may comprise an HyperText Markup Language (HTML) form. The point of contact may comprise one or more of a phone number, an email address, a social media account, etc.

At step 310, second input may be received. The second input may comprise at least one entered point of contact. The at least one entered point of contact may be associated with the user. The point of contact may be entered via a physical keyboard. The point of contact may be entered via a physical keyboard. The point of contact may be entered via a digital keyboard. The point of contact may be entered via a virtual projection keyboard. The point of contact may be entered via a transfer from a user device.

At step 312, each of the plurality of images that comprises an associated privacy setting that allows for public sharing may be caused to be displayed on a public screen. The public screen may be the public display device 120 in FIG. 1. The plurality of images that comprises an associated privacy setting that allows for public sharing may be added to a queue of images taken at an event that are shown on the public screen. The plurality of images that comprises an associated privacy setting that allows for public sharing may be added to the queue as soon as the first input is received. The plurality of images that comprises an associated privacy setting that allows for public sharing may be added to the queue as soon as the second input is received.

At step 314, the plurality of images may be caused to be transmitted to the entered at least one point of contact. Transmitting the plurality of images may comprise transmitting a link to a location which comprises the plurality of images to a location associated with the at least one point of contact. Transmitting the plurality of images may comprise transmitting files as attachments to a location associated with the at least one point of contact. Transmitting the plurality of images may comprise transmitting files as embedded messages to a location associated with the at least one point of contact. Transmitting the plurality of images may comprise transmitting an email. Transmitting the plurality of images may comprise transmitting a Short Message Service (SMS) message. Transmitting the plurality of images may comprise transmitting a Multimedia Messaging Service (MMS) message.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

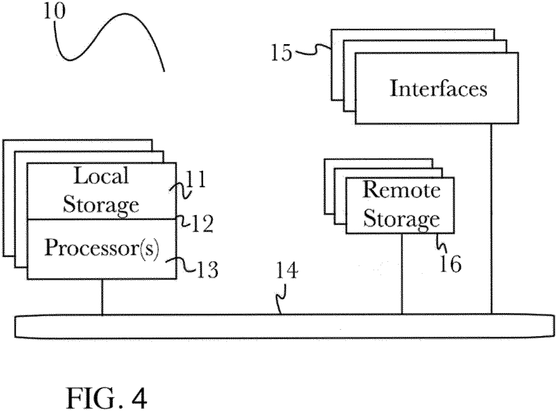

Referring now to FIG. 4, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random-access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 4 illustrates one specific architecture for a computing device 10 for implementing one or more of the embodiments described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, single processor 13 handles communications as well as routing computations, while in other embodiments a separate dedicated communications processor may be provided. In various embodiments, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

The user device 110, the public display device 120, the computing device 134, and/or the server 140 in FIG. 1 may be and/or comprise the computing device 10.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

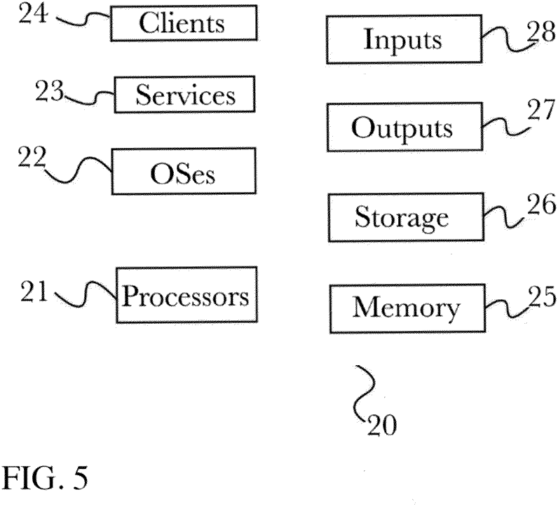

In some embodiments, systems may be implemented on a standalone computing system. Referring now to FIG. 5 above, there is shown a block diagram depicting a typical exemplary architecture of one or more embodiments or components thereof on a standalone computing system. Computing device 20 includes processors 21 that may run software that carry out one or more functions or applications of embodiments, such as for example a client application 24. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 5). Examples of storage devices 26 include flash memory, magnetic hard drive, CD-ROM, and/or the like.

The user device 110, the public display device 120, the computing device 134, and/or the server 140 in FIG. 1 may be and/or comprise the system 20.

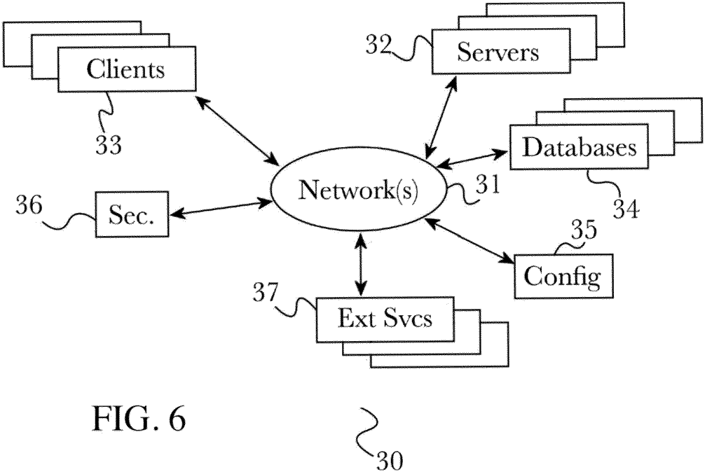

In some embodiments, systems may be implemented on a distributed computing network, such as one having any number of clients and/or servers. Referring now to FIG. 6, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 5. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in one aspect where client applications 24 are implemented on a smartphone or other electronic device, client applications 24 may obtain information stored in a server system 32 in the cloud or on an external service 37 deployed on one or more of a particular enterprise’s or user’s premises.

In some embodiments, clients 33 or servers 32 (or both) may make use of one or more specialized services or appliances that may be deployed locally or remotely across one or more networks 31. For example, one or more databases 34 may be used or referred to by one or more embodiments. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some embodiments may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments without limitation, unless a specific security 36 or configuration system 35 or approach is specifically required by the description of any specific aspect.

The user device 110, the public display device 120, the computing device 134, and/or the server 140 in FIG. 1 may be and/or comprise the one or more of the server(s) 32.

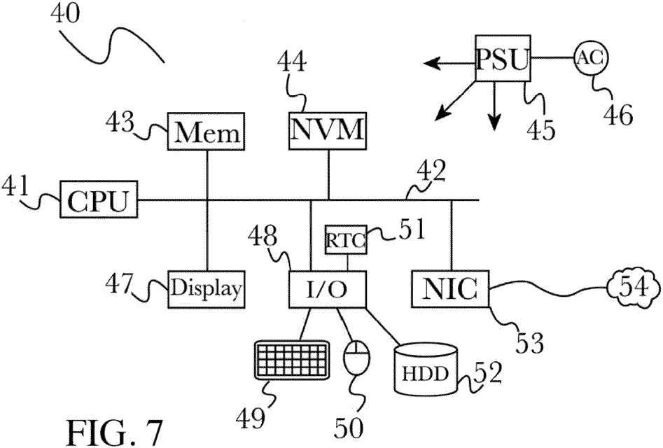

FIG. 7 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

The user device 110, the public display device 120, the computing device 134, and/or the server 140 in FIG. 1 may be and/or comprise the computer system 40.

In various embodiments, functionality for implementing systems or methods of various embodiments may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various embodiments described above. Accordingly, the present invention is defined by the claims and their equivalents.

### Processes for Managing Privacy for Images Captured at a Photo Booth

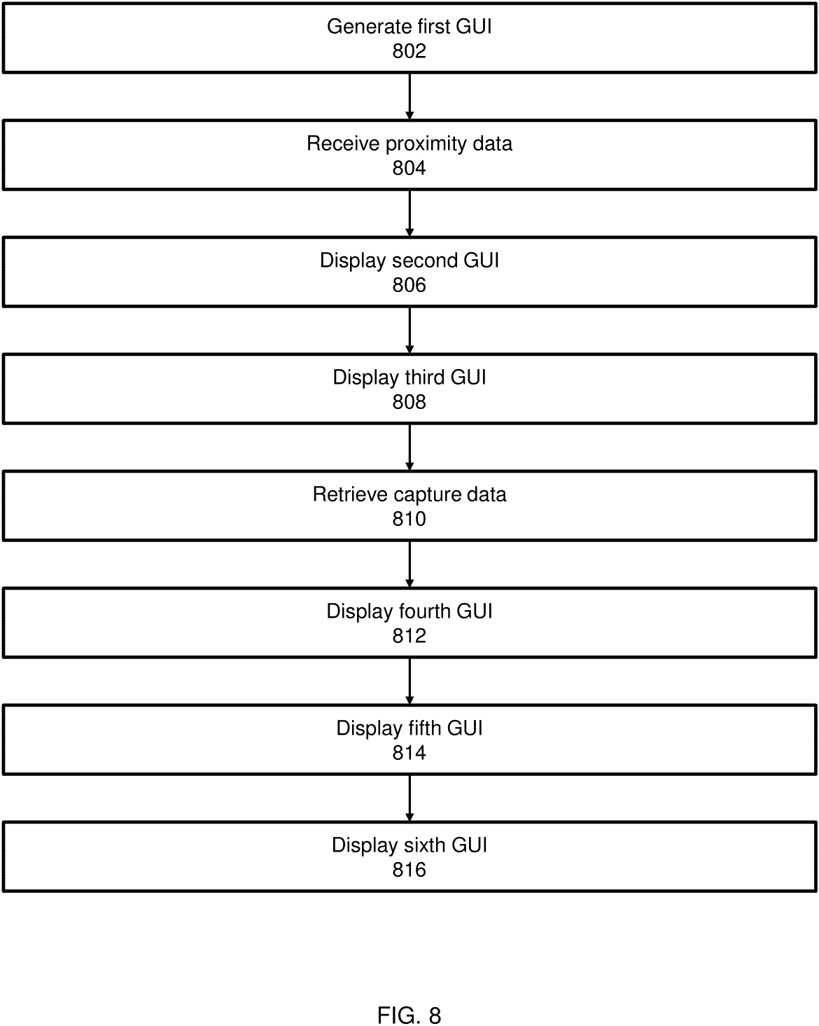

FIG. 8 illustrates, in an example embodiment, method 800 of managing privacy for images captured at a photo booth. In embodiments, the method steps or techniques depicted and described herein can be performed in a processor of the user device 110 in FIG. 1, the method steps being encoded as processor-executable instructions in a non-transitory memory of the user device 110. In embodiments, the method steps or techniques depicted and described herein can be performed in a processor the public display device 120 in FIG. 1, the method steps being encoded as processor-executable instructions in a non-transitory memory of the public display device 120. In embodiments, the method steps or techniques depicted and described herein can be performed in a processor the computing device 134 in FIG. 1, the method steps being encoded as processor-executable instructions in a non-transitory memory of the computing device 134. In embodiments, the method steps or techniques depicted and described herein can be performed in a processor of the server 140 in FIG. 1, the method steps being encoded as processor-executable instructions in a non-transitory memory of the server 140. The techniques of FIG. 8 may be implemented in an operating system kernel, in a separate user process, in a library package bound into network applications, on a specially constructed machine, on an application-specific integrated circuit (ASIC), or a field programmable gate array (FPGA).

At step 802, a first graphical user interface (first GUI) may be generated for display on a first computing device. The first GUI may display images from a shared library.

At step 804, proximity detection data may be received from a sensor. The proximity detection data may suggest that a human is ready to initiate a session. Proximity detection data may comprise data from a depth sensing camera suggesting that a face of a threshold size is detected. Proximity detection data may comprise data from at least one of a proximity sensor and ambient light sensor.

At step 806, a second graphical user interface (second GUI) may be displayed in response to the received proximity detection data. The second GUI may display a start screen that enables a user to initiate the session.

At step 808, a third graphical user interface (third GUI) may be displayed in response to receiving an initiation request. The third GUI may display capture formats available during a session. A user may select at least one capture format. The selected capture format may comprise capturing a single image. The selected capture format may comprise capturing multiple images. The selected capture format may comprise at least a first image and a last image. The selected capture format may comprise replaying the multiple captured images in sequence from the first image to the last image. The selected capture format may comprise replaying the sequence in a loop. The selected capture format may comprise replaying the multiple captured images in a first sequence from the first image to the last image and then in a second sequence from the last image to the first image. The selected capture format may comprise replaying the first sequence and then the second sequence in a loop.

At step 810, data may be captured from an image sensor associated with a camera. The captured data may be capable of being output in the capture format selected by the user. Capturing data from an image sensor associated with a camera may comprise displaying a seventh graphical user interface (GUI). The seventh GUI may comprise a countdown.

At step 812, a fourth graphical user interface (fourth GUI) displaying captured data in the format selected by the user and displaying graphical user interface elements to edit the displayed captured data may be displayed.

At step 814, a fifth graphical user interface (fifth GUI) comprising graphical interface elements displaying privacy options may be displayed. The privacy options may enable a user to at least one of share the captured data privately, share the data publicly with some restrictions, and share the data publicly with no restrictions. A link to access the captured data may be sent to the user. When a user selects to share the data publicly with no restrictions, the captured data may be transmitted to a first database. The database may be accessed for public display on a screen. When a user selects to share the data publicly with some restrictions, the captured data may be transmitted to a first database with flags for selected restrictions. The first database may be accessed for public display in accordance with the selected restrictions.

At step 816, a sixth graphical user interface (sixth GUI) comprising graphical interface elements enabling a user to send captured data in accordance with a privacy selection may be displayed. The sent captured data may be edited.

### Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for streamlining throughput at a photo booth through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A method for displaying graphical user interface (GUI), the method comprising:
generating a first graphical user interface (first GUI) for display on a first computing device, the first GUI displaying images from a shared library;
receiving proximity detection data from a sensor, the proximity detection data suggesting that a human is ready to initiate a session;
displaying a second graphical user interface (second GUI) in response to the received proximity detection data, the second GUI displaying a start screen that enables a user to initiate the session;
displaying a third graphical user interface (third GUI) in response to receiving an initiation request, the third GUI displaying capture formats available during a session, wherein a user can select at least one capture format;
capturing data from an image sensor associated with a camera, the captured data capable of being output in the capture format selected by the user;
displaying a fourth graphical user interface (fourth GUI) displaying captured data in the format selected by the user and displaying graphical user interface elements to edit the displayed captured data;
displaying a fifth graphical user interface (fifth GUI) comprising graphical interface elements displaying privacy options, wherein the privacy options enabling a user to at least one of share the captured data privately, share the data publicly with some restrictions, and share the data publicly with no restrictions; and
displaying a sixth graphical user interface (sixth GUI) comprising graphical interface elements enabling a user to send captured data in accordance with a privacy selection, wherein the sent captured data is edited.

2. The method of claim 1, wherein the selected capture format comprises capturing a single image.

3. The method of claim 1, wherein the selected capture format comprises capturing multiple images.

4. The method of claim 3, wherein the selected capture format comprises at least a first image and a last image.

5. The method of claim 4, wherein the selected capture format comprises replaying the multiple captured images in sequence from the first image to the last image.

6. The method of claim 5, wherein the selected capture format comprises replaying the sequence in a loop.

7. The method of claim 4, wherein the selected capture format comprises replaying the multiple captured images in a first sequence from the first image to the last image and then in a second sequence from the last image to the first image.

8. The method claim of claim 7, wherein the selected capture format comprises replaying the first sequence and then the second sequence in a loop.

9. The method of claim 1, wherein a link to access the captured data is sent to the user.

10. The method of claim 1, wherein, when a user selects to share the data publicly with no restrictions, the captured data is transmitted to a first database, wherein the database may be accessed for public display on a screen.

11. The method of claim 1, wherein, when a user selects to share the data publicly with some restrictions, the captured data is transmitted to a first database with flags for selected restrictions, wherein the first database may be accessed for public display on a screen in accordance with the selected restrictions.

12. The method of claim 1, wherein capturing data from an image sensor associated with a camera comprises displaying a seventh graphical user interface (GUI), wherein the seventh GUI comprises a countdown.

13. The method of claim 1, wherein proximity detection data comprises data from a depth sensing camera suggesting that a face of a threshold size is detected.

14. The method of claim 1, wherein proximity detection data comprises data from at least one of a proximity sensor and ambient light sensor.

15. A system for displaying graphical user interface (GUI), the system comprising a processor and memory, wherein the memory comprising stored instructions that, when executed, cause the processor to:
generate a first graphical user interface (first GUI) for display on a first computing device, the first GUI displaying images from a shared library;
receive proximity detection data from a sensor, the proximity detection data suggesting that a human is ready to initiate a session;
display a second graphical user interface (second GUI) in response to the received proximity detection data, the second GUI displaying a start screen that enables a user to initiate the session;
display a third graphical user interface (third GUI) in response to receiving an initiation request, the third GUI displaying capture formats available during a session, wherein a user can select at least one capture format;
capture data from an image sensor associated with a camera, the captured data capable of being output in the capture format selected by the user;
display a fourth graphical user interface (fourth GUI) displaying captured data in the format selected by the user and displaying graphical user interface elements to edit the displayed captured data;
display a fifth graphical user interface (fifth GUI) comprising graphical interface elements displaying privacy options, wherein the privacy options enabling a user to at least one of share the captured data privately, share the data publicly with some restrictions, and share the data publicly with no restrictions; and
display a sixth graphical user interface (sixth GUI) comprising graphical interface elements enabling a user to send captured data in accordance with a privacy selection, wherein the sent captured data is edited.

16. The system of claim 15, wherein the selected capture format comprises capturing a single image.

17. The system of claim 15, wherein the selected capture format comprises capturing multiple images.

18. The system of claim 17, wherein the selected capture format comprises at least a first image and a last image.

19. The system of claim 18, wherein the selected capture format comprises replaying the multiple captured images in sequence from the first image to the last image.

20. The system of claim 19, wherein the selected capture format comprises replaying the sequence in a loop.
